(19) United States
(12) Patent Application Publication
(10) Pub. No.: US 2006/0283946 A1
(43) Pub. Date: Dec. 21, 2006

(54) Card receiving device

(75) Inventors: Thomas Riester, Villingen-Schwenningen (DE); Torsten Wahler, Bad Durrheim (DE)

Correspondence Address: SIEMENS SCHWEIZ AG;I-47, INTELLECTUAL PROPERTY, ALBISRIEDERSTRASSE 245, ZURICH, CH-8047, CH

(73) Assignee: SIEMENS AKTIENGESELLSCHAFT, Munich (DE)

(21) Appl. No.: 10/554,414

(22) PCT Filed: Mar. 23, 2004
(86) PCT No.: PCT/EP04/03080

§ 371 Date: Oct. 24, 2005

(30) Foreign Application Priority Data
May 12, 2003 (DE) 103 21 203.5

(51) Int. Cl. G06K 7/06; G07B 15/02

(52) U.S. Cl. 235/441; 235/384

(57) ABSTRACT

The invention relates to a card receiving device (1) provided with the flat design comprising at least one locking element (30r, 301). The invention also relates to a method for receiving a card (2). Particular difficulties arise due to the small installation space, legal rules, the inexactnesses of the cards to be used, the environment that is often dirty, and to the ingenuity of manipulation attempts. The aim of the invention is to fulfill the legal requirements and to ensure a good functioning under adverse operating conditions. To this end, the invention provides that the locking element (30r, 301) has at least one contact surface (39r, 391) that touches the card (2) and presses it, at least occasionally, in the direction of insertion (9). The invention also relates to a corresponding method. The invention effectively combines function and security.

The invention relates to a card receiving device, in particular a flat card receiving device for a tachograph in a motor vehicle, which card receiving device draws a card completely into its interior, has an elongate receiving opening through which the card passes into the card receiving device in an insertion direction, and has a locking unit which has at least one locking element which can be moved into the clear cross section of the receiving opening.

The main focus of application of the device according to the invention is in the area of tachographs or devices for recording the operating periods and rest periods of commercial vehicle drivers. However, other applications are also feasible, for example in the area of banking and for making payments, or in locking systems. The invention is advantageously used in combination with all types of card-like data storage media. On account of the great economic and legal importance of the data which can be acquired with tachographs, the recordings have to be reliably secured against manipulation. The security measures relate both to data acquisition and data transmission and to the transmission and storage of the acquired data in the memory of the card. Relevant standards place strict requirements on the security standard to be achieved by the measures. It is therefore stipulated that the card be entirely held by the card receiving device during the reading and writing operations and be isolated from the surroundings by means of suitable closure devices. The closure devices have to be arrested in the closed position during the reading and writing operations. Additional difficulties arise on account of operational failures in conventional devices caused by contamination, in particular by contact being interrupted or even when the card is being drawn in. It is problematical to draw in the card and position it exactly on the contacts of the device because the cards have high manufacturing tolerances in relation to the required positional accuracy with respect to the contacts of the device. Since the cards are predominantly perceived by the user to be distinguished by a high degree of robustness, said cards are generally not handled with the care that is actually required, so that, in addition to the tolerances caused by manufacture, deformation and damage impair the way in which the card operates when interacting with the card receiving devices. Furthermore, the operating conditions in motor vehicles place increased requirements on functional reliability on account of the pronounced vibrations and countless bumps and the wide-ranging temperature fluctuations. Implementing security against manipulation and the desired handling convenience mean it is necessary to draw in the card fully automatically. However, in order to meet this requirement, great difficulties are faced in terms of construction because the installation space available in a tachograph which is the size of a car radio provides only approximately a height of 10 mm for the fully automatic drawing-in process.

Particular difficulties arise firstly on account of the small installation space available, the legal regulations which prescribe that the device be closed and the closure means be arrested, the inaccuracies of the cards which are to be used, the contaminated medium, and imagination when attempting manipulation.

German patent application 101 53 995 has already disclosed a smart-card receiving device with locking means which are designed and mounted in such a way that they can be moved in a plane parallel to the plane of movement of the smart card. In this case, bolt elements are designed in the manner of hooks and surround the end faces of a smart card which is in the write position. However, it has been found that the proposed design has only a low tolerance to incorrect operation, in particular if a card is not inserted into the intended clamping unit as far as the stop. In a case such as this, the device tends to tilt and block in the event of severe faulty positioning, and to make incorrect contact with the smart card in the write position when said device is only slightly incorrectly positioned.

On the basis of the problems and disadvantages of the prior art, the invention is based on the object of providing a card receiving device which satisfies relevant provisions relating to the security of a card which is to be received in the device, has a high tolerance to the faulty insertion of cards, and ensures reliable contact is made with the card which is to be received, particularly under adverse conditions.

According to the invention, the object is achieved by a card receiving device of the type mentioned in the introduction in which the locking element has at least one abutment area which touches the card located in the card receiving device at the outwardly pointing end face or in the region of a corner or rounded section of the card which adjoins this end face, and at least temporarily presses said card in the insertion direction.

One crucial advantage of the invention is the dual function of the locking element which firstly blocks the receiving opening in accordance with regulations, with the result that the remaining clear cross section is too small for a card to be able to pass through it, and secondly finely positions the card in the card receiving device, as may be necessary, so that contact can be made in a reliable manner.

In order for the apparatus to combine as flat a construction as possible with reliable operation, it is expedient when the card moves in the insertion direction essentially in an insertion plane.

Since the locking element is preferably mechanically manipulated with fraudulent intent, it is expedient when said locking element is rotatably mounted about a first rotation axis and in this way a high degree of robustness can be achieved by utilizing lever ratios. In addition, the rotary movement of the locking element which takes place in only small amplitudes can be implemented in a space-saving manner in the small installation space available, in particular when the first rotation axis runs perpendicular to the insertion plane of the card. One further advantage of the rotary movement of the locking element is the degree of freedom of movement being restricted to the minimum extent required, so that, with the risk of tilting being excluded, the card receiving device expediently has a slotted-link-like first guide, and the locking element advantageously has a first guide element in the form of a sliding block which is guided in the first guide in such a way so that the locking element can be moved into a locking position and out of the locking position, in particular can be pivoted about the first rotation axis in this case. Arranging the first rotation axis perpendicular to the insertion plane of the card has proven particularly expedient here because the movement in the circumferential direction expediently blocks the receiving opening when the locking element is arranged in a corresponding manner. The advantages of the slotted-link-like first guide have an effect particularly when the first guide is a constituent part of an actuating lever which can be rotated about a second rotation axis. Equally good success can be achieved when, in kinematic reverse, a first guide element is a constituent part of the rotatable actuating lever and the first guide is part of the locking element. In this case, the rotation of the locking element may be given any desired characteristics regarding the shape of the slotted-link-like first guide. On account of the actuating lever being mounted about a second rotation axis, the device is particularly well suited to being coupled to a rotary actuator in the manner of a gear system.

Particularly good results are achieved in terms of finely positioning the card which is to be received when the locking element has an abutment piece which is movably fitted to said locking element, at least temporarily bears against the card at the outwardly pointing end face or in the region of a corner or rounded section of the card which adjoins this end face, and at least temporarily presses the card in the insertion direction. The ability of the abutment piece to move allows all of the dimensions occurring in the tolerance range of standardized cards to be taken into account, with the result that it always possible to make contact in a reliable manner. In order to make the fine-positioning of the card in the apparatus independent of the unreliability of the dimensional tolerance of the entire card too, it is expedient when the abutment piece is spring-mounted on the locking element and in this way the abutment piece can permanently butt against the card.

A first leaf spring is particularly well suited to spring-mounting the abutment piece. In this case, the first leaf spring is expediently designed with a spring path which is oriented transverse to the insertion direction and parallel to the insertion plane of the card which is to be received, advantageously designed as part of the locking element.

In order to finely position the card in a reliable manner, it is expedient when the locking element has a certain excess travel in relation to the average dimensions of a card which is to be received, and the abutment piece is movably mounted on the locking element essentially tangentially to the circumferential direction of the first rotation axis of the locking element and in this way can compensate for the excess travel of the locking element, with the result that the card is clamped by means of the spring force of the spring mount when the abutment piece butts against it. Particularly when the abutment piece butts against the card at a corner or rounded section which adjoins the outwardly pointing end face during an inward-movement phase, it is expedient when an abutment area on the abutment piece is oriented obliquely to the direction of movement of the abutment piece in relation to the locking element. In this case, the oblique orientation ensures that the card is pressed in the inward direction when the abutment piece can move tangentially to the circumferential direction of the first rotation axis of the locking element and is elastically prestressed in this direction.

In order to fully satisfy the relevant regulations, it is advantageous to arrest the locking element, in which case an arresting element is fitted to at least one locking element, can be moved to an “arrested position”, and arrests the locking unit in a “locked position”. In this case, the arresting element is preferably designed to be loaded with a shearing load when an attempt is made to open the locking system. A cost-effective solution for the arresting action is achieved when an arresting element is fitted precisely to a locking element. A design of the arresting element which both arrests the locking element in the “locked position” and restricts the mobility of the abutment element in this position has proven particularly expedient. Mobility should be expediently restricted in such a way that the abutment piece has so much play with respect to the arresting element in the “arrested position” that it can move in a sprung manner to the extent of tolerances of the card to width, length and form, and the abutment piece has so little play with respect to the arresting element in the “arrested position” that the clear width of the receiving opening is blocked to such an extent that the card cannot be removed. Irrespective of the movement phase, in particular for restricting the mobility of the abutment piece, the arresting element is always in the advantageously correct position in the device when the arresting element is movably fitted to the locking element. In this way, the tolerance chain between the abutment piece and the arresting element is reduced to a minimum, and this is important predominantly with regard to the mobility of the abutment piece and the generous tolerance range of relevant cards. One expedient design of combining the arresting element with the locking element makes provision for the arresting element to be able to move in a translatory fashion in relation to the locking element and be mounted on the locking element such that it can slide. In this way, the arresting element may be arranged in a space-saving manner at the side of the receiving shaft of the card receiving device as an elongate component with a main direction of extent in the insertion direction. It is equally advantageous to arrange elongate locking elements which extend in the insertion direction at the side of the receiving shaft of the device. One advantageous development makes provision for the arresting element to be able to be controlled and moved by means of an actuating lever, with the same actuating lever expediently controlling and moving both the locking element or elements and the arresting element or elements.

One expedient variant comprises two locking elements, with the card receiving device having two locking elements which are arranged in mirror-image fashion with respect to one another on a middle plane of a receiving shaft which is oriented perpendicular to the drawing-in plane, and at the side of the receiving shaft. These two locking elements are each preferably mounted about parallel first rotation axes, and the locking elements execute opposing movements when the actuating lever moves. An expedient design of the locking system is one in which the locking elements move toward one another in the manner of tongs at the side of the receiving opening when moving to the “closed position”.

For the purpose of advantageous tactile detection, it is expedient when the card receiving device has a stop for the card at the end of a card receiving shaft. At the same time, this stop is used to precisely position the card in the device and should therefore be arranged with a narrow tolerance to a set of contacts of the device, which set of contacts makes contact with the card. Designing the stop and the set of contacts in the form of an integral component assists tolerance accuracy. In order to achieve suitable fine-positioning and the correct position of the card over a long period of time, even in the event of severe vibrations, it is expedient when the card is permanently pressed against the stop in the end position by means of an elastic element. The abutment piece on the locking element is particularly highly suitable for this purpose.

To satisfy the relevant protection classes, for example IP 54, in particular, it is expedient when the card receiving device has a closure means which extends in the longitudinal direction of the receiving opening and blocks or closes the receiving opening in the “closed position” of the closure means. The closure means is preferably intended to close off the receiving opening from the surroundings in a dust-tight and splashproof manner. For the purposes of maximum robustness and when only a small installation space is available, it is expedient when the closure element can move in the normal direction of the insertion plane for the travel required to receive the card. More installation space is saved as a result of spring-mounting the closure element on the card receiving device by means of at least one elastic element. In this way, any possible driving of the movement of the closure means may be replaced in a cost-effective manner by the closure means sliding on both sides or being displaced by means of a card which is manually inserted into the receiving opening. The greatest success with minimum outlay is achieved when the elastic element is a second leaf spring, and the second leaf spring can be blocked in the “closed position” of the closure means by means of the locking element of the locking unit. For example, when the closure means is in the “closed position” at the point of maximum amplitude of movement of the second leaf spring, that locking element of the locking unit which can be moved in the movement space of the second leaf spring can expediently restrict the mobility of the second leaf spring. One expedient development makes provision for the closure element to be able to be locked in the “closed position” by means of the locking unit. Mobility of the locking element of the locking unit in a plane essentially parallel to the card moving in the card receiving device, in particular an ability to rotate, is conducive to a flat construction.

The advantages of the invention particularly have an effect when the card can be automatically drawn in and automatically ejected. Even if the devices are not fully automatic, it is problematical to satisfy the safety standards since the card must not be accessible in the write position and it is therefore not possible to manually assist transportation of the card into the end position on the set of contacts.

The invention also relates to a method for receiving a card in a card receiving device, in particular a flat card receiving device for a tachograph in a motor vehicle, which card receiving device draws a card completely into an insertion plane, has an elongate receiving opening through which the card passes into a receiving shaft of the card receiving device, and has a locking unit which has at least one locking element which can be moved into the clear cross section of the receiving opening.

Widely known methods of the abovementioned type similarly have disadvantages, as do the devices which have been explained above and are provided for these methods.

In order to achieve the above object, a method of the abovementioned type is proposed, in which the locking element temporarily bears the card located in the card receiving device at the outwardly pointing end face or in the region of a corner or rounded section of the card which adjoins this end face, and at least temporarily presses the card in the insertion direction.

The advantages explained above are accompanied by the card being permanently pressed against a stop by means of the locking element during a writing operation. In one specific embodiment of the method according to the invention, it is particularly advantageous when a clamping unit clamps the card in a first step, the card is transported into the card receiving device in a second step, the clamping action of the card is released from the card in a third step, and the locking unit pushes the card to an end position in a fourth step. The use of a clamping unit for fixing and for transporting the card makes a substantial contribution to saving installation space in accordance with the object, and, according to the invention, reliable contact is made with the card by the clamping unit releasing said card after it has been drawn into the device and by the card being pushed into the end position provided for the data-transmission operation. The locking element expediently permanently presses the card against a stop during data-transmission operations.

In order to illustrate the invention, a specific exemplary embodiment is explained below with reference to drawings, in which

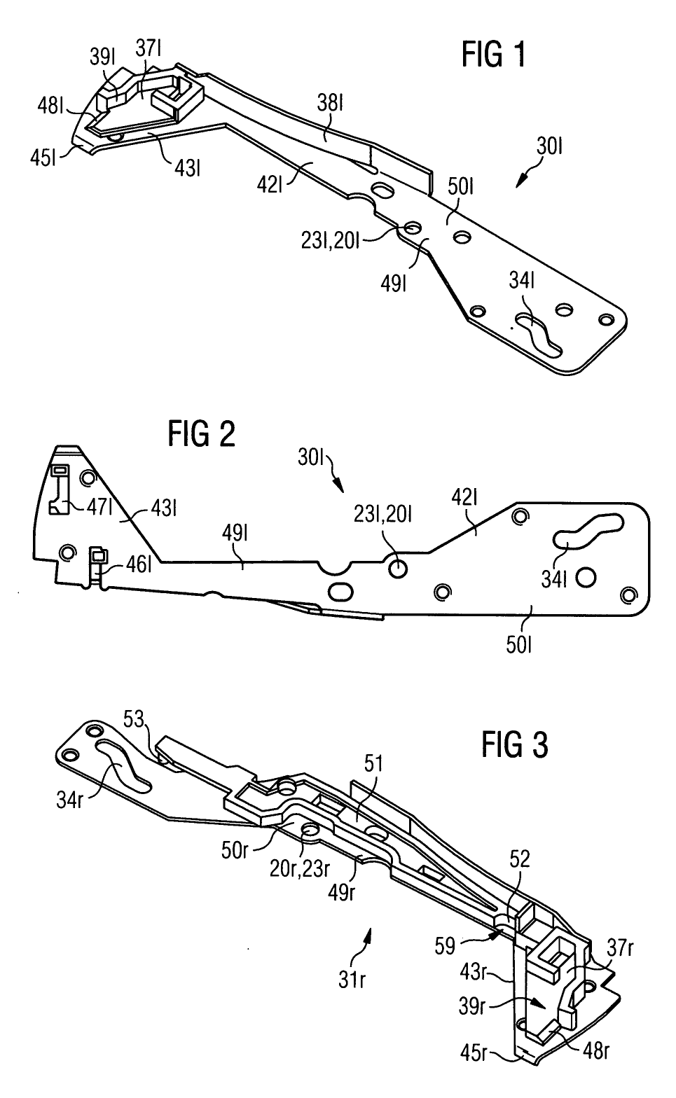

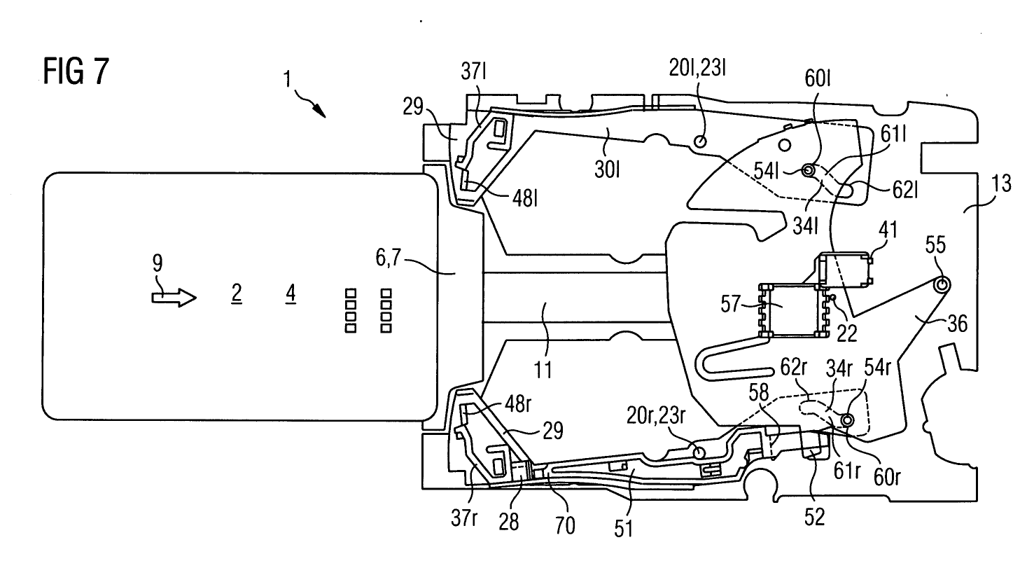

FIG. 1 shows a perspective illustration of a locking lever which is arranged on the left-hand side in the card receiving device illustrated in FIGS. 7 to 13,

FIG. 2 shows a view from below of the locking lever from FIG. 1,

FIG. 3 shows a perspective illustration of a locking lever which is arranged on the right-hand side in the card receiving device illustrated in FIGS. 7 to 13,

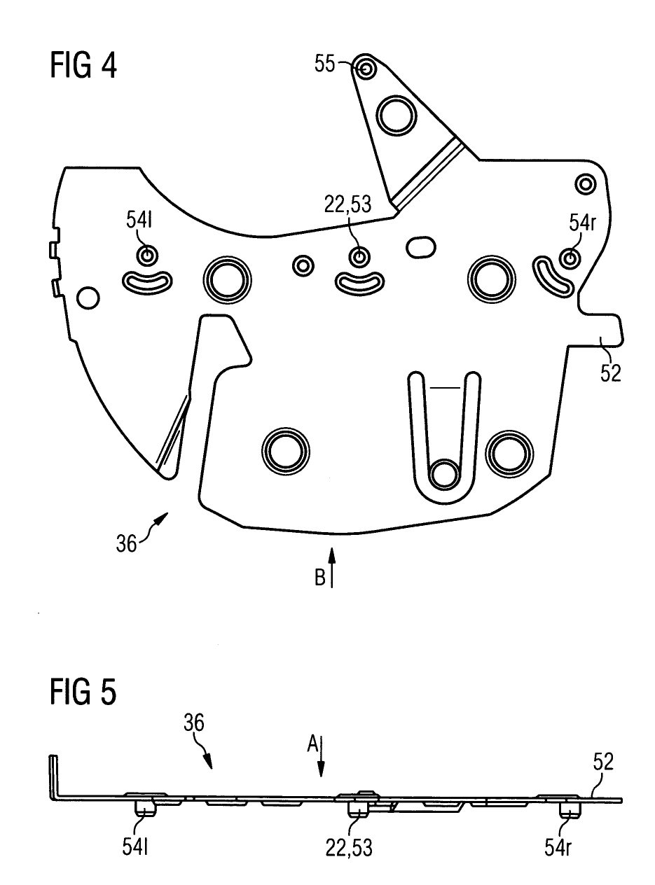

FIG. 4 shows a plan view of an actuating lever in accordance with the viewing direction A indicated in FIG. 5,

FIG. 5 shows a side view of an actuating lever in accordance with the viewing direction B indicted in FIG. 4,

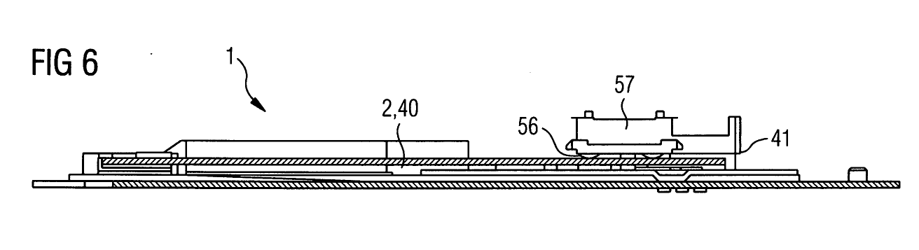

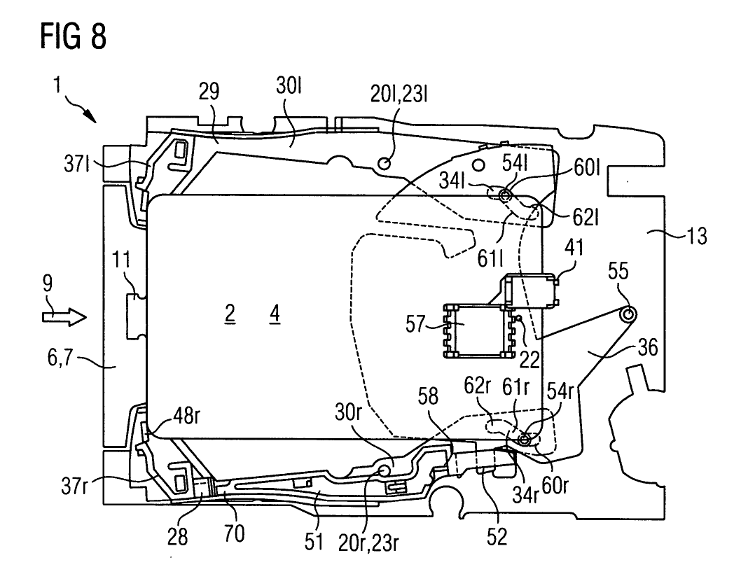

FIG. 6 shows a longitudinal section through an inventive device in accordance with the section H-H from FIG. 8,

FIG. 7 shows a plan view of a card receiving device according to the invention with a card in a movement phase before the card is introduced into the receiving opening,

FIG. 8 shows a plan view of a card receiving device according to the invention in a movement phase in which the card is just in front of the stop of the receiving shaft,

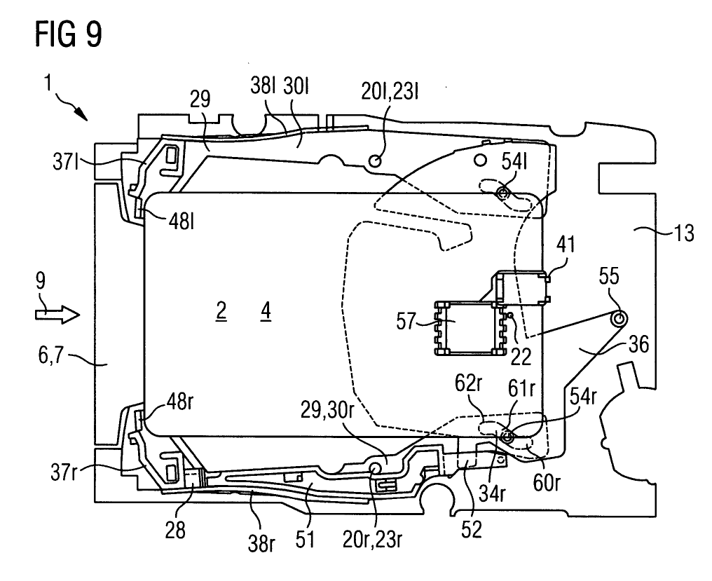

FIG. 9 shows a plan view of a card receiving device according to the invention in a movement phase in which the card is at the stop of the receiving shaft and the locking unit starts the locking process,

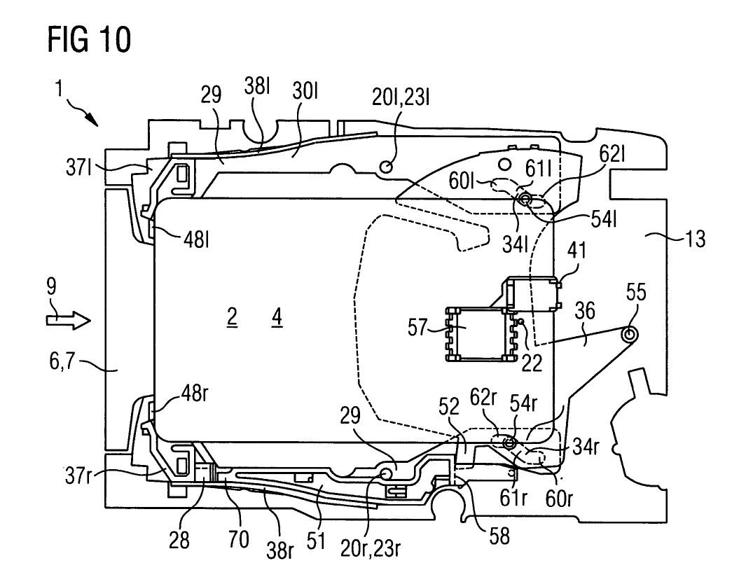

FIG. 10 shows a plan view of a card receiving device according to the invention in a movement phase in which the process of locking is just about to end and the arresting process is starting,

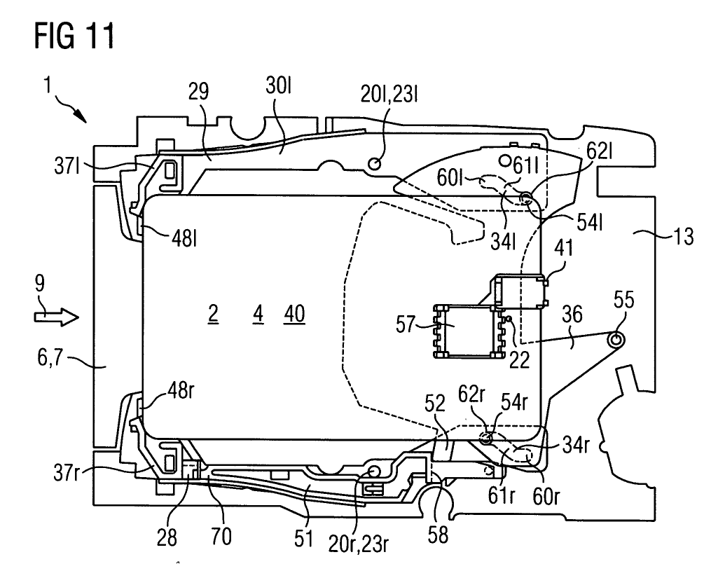

FIG. 11 shows a plan view of a card receiving device according to the invention in a movement phase in which the locking system is arrested,

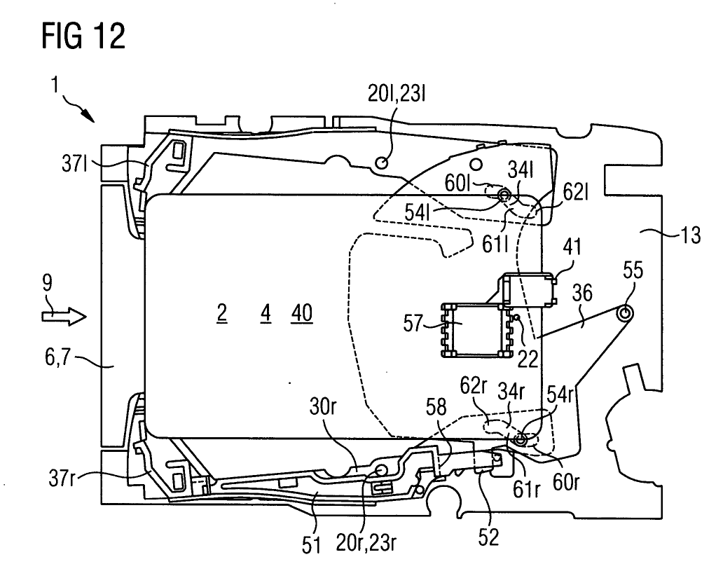

FIG. 12 shows a plan view of a card receiving device according to the invention in a movement phase in which the locking elements are open, the arresting action has not yet been cancelled and ejection of the smart card is imminent, and

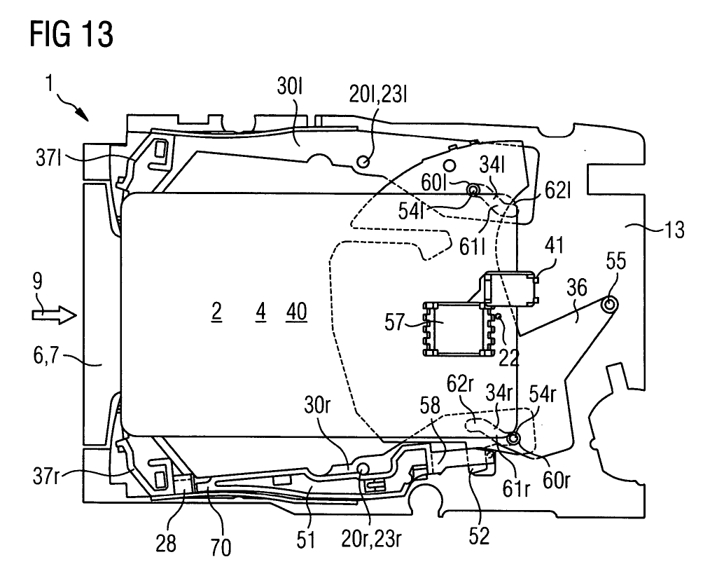

FIG. 13 shows a plan view of a card receiving device according to the invention in a movement phase in which the arresting action is completely released and the card is moved out of the receiving shaft.

The locking element 301 illustrated in FIGS. 1 and 2 is provided with the reference symbol 301 and essentially comprises a flat, elongate lever 421, an abutment piece 371 and a first leaf spring 381. The lever 421 has a base body 491 and an extension arm 431 which is arranged in the card receiving device 1 at the input end and points into the middle of a receiving shaft 40 for a card 2 in the form of a projection in the assembled state. The abutment piece 371 is mounted in the region of the extension arm 431 such that it can slide and can be linearly displaced on the locking element 301. The locking element 301 has a first mount 231 for a first pin 441 which is illustrated in FIGS. 7-13 and is rotatably mounted in a first rotation axis 201. The first rotation axis 201 is arranged between the abutment piece 371 and a first guide 341. The extension arm 431 is provided with a slope 451 which rises in the circumferential direction to the first rotation axis. The abutment piece 371 is essentially tangentially mounted such that it can slide in each case linearly in a third guide 461 and fourth guide 471 in the circumferential direction to the first rotation axis, and bears against the first leaf spring 381. The first leaf spring 381 extends essentially in the insertion direction 9 and has a spring path which is oriented transverse to the insertion direction 9 and parallel to the insertion plane 4. The abutment piece 371 has a run-in slope 481 which is intended for a card 2 and rises in the insertion direction 9. The abutment piece 371 is provided with an abutment area 391 which runs obliquely to a tangent to the circumferential direction to the first rotation axis 201. The base body 491 of the lever 421 comprises a punched-out sheet-metal shape which has the first leaf spring 381 in the form of an integral constituent part, with the first leaf spring 381 being bent at right angles to a base plate 501 of the lever 421.

The locking element 30r which is illustrated in FIG. 3 and arranged on the right-hand side in the card receiving device 1 is designed in mirror-image fashion essentially in the same way with regard to a first mount 23r in a first rotation axis 20r, a first guide 34r, a first abutment piece 37r, an abutment area 39r, a lever 42r, an extension arm 43r, a first pin 44r, a slope 45r, a third guide, a fourth guide, a run-in slope 48r, a base body 49r and a base plate 50r, but on a plane perpendicular to an insertion plane 4 of the receiving shaft 40 of the card receiving device 1.

In addition, an arresting element 51 is movably fitted on the right-hand locking element 30r. The arresting element 51 is mounted such that it can slide in linear guides (not illustrated in any more detail) on the base plate 50r of the base body 49r of the lever 42r. At an end which faces the abutment piece 37r, the arresting element 51 is provided with a tapered first shaped portion 70 which corresponds to a recess 59 (not illustrated in any more detail) on the abutment piece 37r in such a way that, in an “arrested position”, mobility in the linear mount of the abutment piece 37r is restricted to an amount of play which corresponds essentially to the manufacturing tolerance of the card 2 which is to be received.

The actuating lever 36 illustrated in FIGS. 4 and 5 operates the two locking elements 301, 30r of a locking unit 29 and the arresting element 51 movably fitted to the locking element 30r by means of rotation about a third pin 53 mounted on a support 13 which is arranged in a second rotation axis 22, combines all of the components and is illustrated in FIGS. 7 to 13. The locking elements 301, 30r are controlled by means of fourth pins 541, 54r which are arranged on both sides of the second rotation axis 22. The fourth pins 541, 54r interact with the first guides 341, 34r of the locking elements 301, 30r. The actuating lever 36 is provided with a fifth pin 55 which is guided in a slotted-link-like guide (not illustrated) and by means of which movements in the various movement phases are indirectly impressed on the locking unit 29 and the arresting element 51 via the actuating lever 36. In one movement phase, a second shaped portion 52 on the actuating lever 36 is used to introduce force onto the arresting element 51 by means of the third pin 53.

FIG. 6 shows a cross section through a card receiving device 1 according to the invention in a movement phase in which the inserted card 2 is just in front of a stop 41 arranged at the end of the receiving shaft 40. Contacts 56 of a set 57 of contacts are just about to make contact with a flat face of the card 2 in a final data-transmission position.

During the movement phase of a card 2 in a card receiving device 1 according to the invention, which phase is illustrated in FIG. 7, the locking unit 29 which comprises the locking elements 301, 30r is completely open. As part of the insertion movement, the card 2 slides along the run-in slopes 481, 48r provided on both sides on the locking elements 301, 30r respectively, and into the interior of the card receiving device 1. Here, the card 2 is grasped by a clamping unit (not illustrated) and transported in the insertion direction 9 along an insertion plane 4. In this case, the card 2 is inserted through an insertion opening (not illustrated) which can be closed in a dust-tight and splashproof manner by means of a closure means 6. A closure element 7 of the closure means 6 is spring-mounted in the normal direction of the insertion plane 4 by means of a second leaf spring 11. In this case, the second leaf spring 11 is a constituent part of-a central support 13 to which all of the functionally important components of the card receiving device 1 according to the invention are fitted. The support 13 is a sheet-metal part which is provided with recesses and with injection-molded plastic parts using the outsert technique.

During the movement phase illustrated in FIG. 8, the card 2 is just in front of a stop 41 which is a fixed constituent part of the set 57 of contacts. A force in the fifth pin 55 in the direction of the locking element 30r arranged on the right-hand side causes the actuating lever 36 to rotate in the mathematically positive direction, with the result that the fourth pins 541, 54r move about the second rotation axis 22 in the first guides 341, 34r of the locking elements 301, 30r. In a first region 601, 60r through which the first pins 441, 44r pass in this movement period, the first guides 341, 34r are formed concentrically with respect to the second rotation axis 22 of the actuating lever 36 about the second rotation axis 22, with the result that the movement of the actuating lever 36 does not lead to the locking elements 301, 30r rotating in this movement phase.

During the movement phase of the card in the card receiving device 1 according to the invention, which phase is illustrated in FIG. 9, the card 2 hash come into contact with the stop 41 of the set 57 of contacts, the fourth pins 541, 54r of the actuating lever 36 have left the first region of the first guides 341, 34r which are formed concentrically around the second rotation axis 22, and run through a second region 611, 61r of the first guides 341, 34r which is not formed concentrically with respect to the second rotation axis 22, so that the locking elements 301, 30r rotate about the first rotation axes 201, 20r. At the same time as the card 2 reaches the stop 41 of the set 57 of contacts, the clamping action on the card 2 is released, with the result that the locking unit 29 can finely position the card by means of the abutment pieces 371, 37r. The abutment pieces 371, 37r engage from both sides in opposite directions into the region of the receiving opening (not illustrated) of the card receiving device 1.

The result of continued introduction of force on the fifth pin 55 of the actuating lever 36 is that the locking process is almost completed during the movement phase of the card 2 in the card receiving device 1, which phase is illustrated in FIG. 10. In a third region 621, 62r, the first guides 341, 34r of the locking elements 301, 30r are formed concentrically around the second rotation axis 22 of the actuating lever 36 in the same way as in the first region, with the result that the locking elements 301, 30r do not rotate despite the actuating lever 36 rotating. The section shaped portion 52 of the actuating lever 36 touches a contact area 58 of the arresting element 51 in the illustrated movement phase.

During the movement phase illustrated in FIG. 11, the first shaped portion 70 pushes the tapered, receiving-opening end of the arresting element 51 behind a corresponding recess 28 in the abutment piece 37r, with the result that mobility of the abutment piece 37r is restricted.

Reversing the introduction of force onto the fifth pin 55 of the actuating lever 36 reverses rotation of the actuating lever 36 about the second rotation axis 22, so that the fourth pins 541, 54r move from the third region in the direction of the first region along the first guides 341, 34r, so that the locking elements 301, 30r move from the “closed position” to the original “open position”. The arresting element 51 initially remains in the “arrested position” and is moved from this position only during the movement phase illustrated in FIG. 13 when the second shaped portion 52 reaches and drives the third pin 53. In this way, the movement of the arresting element 51 is given a hysteresis characteristic during the receiving movement and ejecting movement of the card receiving device 1.

1. A flat card receiving device for a tachograph in a motor vehicle, the device comprising:
means for drawing the card completely into a device comprising:
an elongate receiving opening through which the card passes into the device in an insertion direction,
a locking unit including at least one locking element arranged to be moved into a clear cross section of the receiving opening,
wherein the locking element includes at least one abutment area arranged to touch a card located within the device at an outwardly pointing end face or in a region of a corner or rounded section of the card which adjoins an end face, and at least temporarily presses said card in the insertion direction.

2. The card receiving device according to claim 1, further comprising means for moving the card in the insertion direction essentially in an insertion plane.

3. The card receiving device according to claim 1, wherein, the locking element is arranged to be rotatably mounted about a first rotation axis.

4. The card receiving device according to claim 3, wherein the first rotation axis runs perpendicular to the insertion plane of the card.

5. The card receiving device according to claim 1, wherein the card receiving device further comprises:
a slotted-link-like first guide, and
wherein the locking element comprises a first guide element being a sliding block, the locking element is arranged to be moved into a locking position and out of the locking position by means of the first guide and the first guide element, as well as pivoting about a first rotation axis.

6. The card receiving device according to claim 5, further comprising an actuating lever arranged to be rotated about a second rotation axis, the lever comprising the slotted-link-like first guide.

7. The card receiving device according to claim 5, wherein, the locking element comprises an abutment piece arranged to be movably fitted to said locking element, so as to at least temporarily bears against the card at the outwardly pointing end face or in the region of a corner or rounded section of the card which adjoins the end face, and at least temporarily presses the card in the insertion direction.

8. The card receiving device according to claim 7, wherein the abutment piece is spring-mounted on the locking element.

9. The card receiving device according to claim 7, wherein the abutment piece is spring-mounted by means of a first leaf spring.

10. The card receiving device according to claim 7 wherein, the abutment piece is movably mounted on the locking element essentially tangentially or at an acute angle to a circumferential direction of the first rotation axis of the locking element.

11. The card receiving device according to claim 7, wherein, the abutment piece comprises an abutment area is oriented obliquely to a direction of movement of the abutment piece in relation to the locking element, said abutment area arranged to bear against the card at an outwardly pointing corner or rounded section during an inward-movement phase.

12. The card receiving device according to claim 1, further comprising, an arresting element fitted to at least one locking element such that it can be moved to an “arrested position”, and arrest the locking unit in a “locked position”.

13. The card receiving device according to claim 12, wherein the arresting element is fitted precisely to a locking element.

14. The card receiving device according to claim 12, wherein, the arresting element is arranged to restrict mobility of the abutment piece in the “arrested position”.

15. The card receiving device according to claim 14, wherein the abutment piece has sufficient play with respect to the arresting element in the “arrested position” such that it can move in a sprung manner within tolerances of the card to width, length and form, and the abutment piece has sufficiently little play with respect to the arresting element in the “arrested position” that the clear width of the receiving opening is blocked to such an extent that the card cannot be removed.

16. The card receiving device according to claim 14, wherein, the arresting element is arranged to be movably fitted to the locking element.

17. The card receiving device according to claim 14, wherein, the arresting element is arranged to be movable in a translatory fashion in relation to the locking element and is mounted on the locking element such that it can slide.

18. The card receiving device according to claim 1, wherein, the arresting element is arranged to be controlled and moved by means of an actuating lever.

19. The card receiving device according to claim 1, where, said card receiving device further comprises two locking elements arranged in mirror-image fashion with respect to one another on a middle plane of a receiving shaft oriented perpendicular to the insertion plane, and at the side of the receiving shaft.

20. The card receiving device according to claim 1, wherein, the card receiving device further comprises a stop for the card at the end of a receiving shaft.

21. The card receiving device according to claim 1, where, the card is permanently pressed against the stop in the end position by means of an elastic element.

22. The card receiving device according to claim 7, wherein, the card is permanently pressed against the stop in the end position by means of the abutment piece.

23. The card receiving device according to claim 20, wherein, the stop is fixed to a set of contacts.

24. The card receiving device according to claim 23, wherein the card receiving device further comprises a closure means which extends in the longitudinal direction of the receiving opening and blocks the receiving opening in the “closed position” of the closure means.

25. The card receiving device according to claim 23, wherein, the closure element can be moved in the normal direction of the insertion plane for the travel required to receive the card.

26. The card receiving device according to claim 23, wherein, the closure element is spring-mounted on the card receiving device by means of at least one elastic element.

27. The card receiving device according to claim 26, wherein the elastic element is a second leaf spring, and the second leaf spring is arranged to be blocked in the “closed position” of the closure means by means of the locking element of the locking unit.

28. The card receiving device according to claim 23, wherein, the closure element is integrally fitted to at least one second leaf spring.

29. The card receiving device according to claim 23, wherein, the closure element is spring-mounted in the normal direction of the insertion plane for the travel required to receive the card.

30. The card receiving device according to claim 23, wherein, the closure means is arranged to be locked in the “closed position” by means of the locking unit.

31. The card receiving device according to claim 1, wherein the locking element is arranged to be moved and/or rotated, in a plane essentially parallel to the card moving in the card receiving device.

32. The card receiving device according to claim 1, wherein the card is arranged to be, automatically drawn in.

33. The card receiving device according to claim 1, wherein, the card is arranged to be automatically ejected.

34. The card receiving device according to claim 1, wherein, the card receiving device further comprises a set of contacts for making contact with the card.

35. A method for receiving a card in a card receiving device, the card being substantially flat and the receiving device being configured for operation within a motor vehicle, the method comprising the steps of:
drawing the card by the card receiving device completely into an insertion plane, the device comprising an elongate receiving opening through which the card passes into a receiving shaft of the card receiving device, the receiving device further comprising a locking unit having at least one locking element arranged to be moved into a clear cross section of the receiving opening,
temporarily bearing upon the card by the locking element at the outwardly pointing end face or in the region of a corner or rounded section of the card which adjoins this end face, and
at least temporarily pressing the card in the insertion direction.

36. The method according to claim 35, wherein the locking element permanently presses the card against a stop during writing operations and/or reading operations.

37. The method according to claim 35, further comprising the steps of:
clamping upon the card with a clamping unit, in a first step,
transporting the card into the receiving device in a second step,
releasing the clamping action in a third step, and
pushing the card, with the locking unit, to an end position in a fourth step.

38. The method according to claim 37, wherein, in the fourth step, the locking unit pushes the card to an end position in which first contacts of a set of contacts are connected to contact areas on the card.

39. The method according to claim 38 further comprising the step of reading information from the card or stored in the card in a fifth step.
